(19) United States
(12) Patent Application Publication
(10) Pub. No.: US 2006/0259933 A1
(43) Pub. Date: Nov. 16, 2006

(54) Integrated mobile surveillance system

(76) Inventors: Alan Fishel, Long Beach, CA (US); James Finlayson, Eugene, OR (US); John Michael Davis, Sherman Oaks, CA (US)

Correspondence Address: PATENT LAW & VENTURE GROUP, 2424 S.E. BRISTOL, SUITE 300, NEWPORT BEACH, CA, 92660, US

(21) Appl. No.: 11/126,595

(22) Filed: May 10, 2005

(51) Int. Cl. H04N 7/173; H04N 7/18

(52) U.S. Cl. 725/105; 348/159

(57) ABSTRACT

A mobile video surveillance apparatus comprises a single equipment chassis and enclosure within a motor vehicle, and plural video cameras mounted on the motor vehicle; the chassis incorporating a power converter interconnected for operation from a battery source, an embedded computer including a cellular wireless network device, a video capture circuit interconnected with multiple video cameras for receiving transmitting and recording video signals therefrom, storage capability, a signal amplifier whereby the video signals are able to be transmitted via the public cellular network via Internet to selected remote locations and remote viewers are able to select each of the plural video camera feeds for viewing via the Internet.

### BACKGROUND OF THE INVENTION

1. Related Applications:

none

2. Field of the Invention

This invention relates generally to surveillance systems and more specifically to a mobile system comprising a single chassis.

3. Description of Related Art

The following art defines the present state of this field and each U.S. disclosure is hereby incorporated herein by reference:

Monroe, et al., U.S. 2002/0170064 discloses an enhanced, digitized security system that provides wireless, portable monitoring and control capability for a system having a plurality of cameras in a network and connected to a suitable hub. The portable module is also in wireless communication with a server. The permits remote installation and aiming of the cameras, remote viewing, remote database access and remote capture of information for transmission to the database server such as images, video, and other security data for archiving and management. A transmitter is associated with the hub for transmitting the signals via a wireless network to a portable, handheld receiving station, wherein any of the cameras on the network may be accessed and displayed on the portable station display screen. The portable station also includes a transmitter for transmitting control information back to the hub for controlling each of the cameras, permitting full control of the cameras for adjusting contrast, hue, brightness, pan, tilt and zoom, and focus. The multi-camera system is also connected to a server via the hub and the portable station can communicate with the server via the wireless hub to access stored data for retrieval and replay. The system also supports ancillary features such as remote access to student or employee records anywhere the portable unit is used, ID verification by use of a magnetic reader or bar code reader provided on the portable unit and other identification systems such as, by way of example, biometric sampling. Access control devices may be controlled at the portable module, permitting controlled access to various facilities as the user moves about with the portable station. Full communication capability is provided, with communication links to e-mail, telephone and other communication networks and systems. The system is enhanced to selectively notify designated personnel either at the fixed stations or at the portable, wireless stations, upon detection of a motion event, or any other event detectable by the system.

Waldenmaier, U.S. Pat. No. 5,774,569, discloses a method and apparatus that processes a video image signal to generate one or more random number generator seeds. Preferably, the video image signal represents a scene that is both unpredictable and “live”. As a result, potential interceptors of signals encrypted with a random number sequence derived from the seed will find it difficult, if not impossible, to determine the random number sequence. To further obscure the random number sequence from potential interceptors, a seed derived by processing a first video image signal is determined and is stored. Then, a second video image signal is received and a third video image signal is received. A difference is determined between the third video image signal and the second video image signal. If the difference exceeds a threshold (indicating that the scene represented by the video image signals is “live”), then the third video image signal is processed to generate a seed. Alternately, if the difference does not exceed the threshold, then a random number generator seed derived by processing the third video image signal may be more easily determined by an interceptor. In this instance, a previously determined seed is provided as a determined seed.

Johnson et al., U.S. 2002/0184641 discloses a communications system incorporating a plurality of vehicle mounted web cams that collect video information and transmit the video information together with other local information via a wireless network to a server. The video streams from the web cams and associated information are available to users on an internet web page. Each camera has a specific identifier to permit users to access the video of specific individual cameras. Optimization software permits users to take virtual trips along predetermined routes. The system also permits sequential access to multiple video feeds from desired locations. Multiple alternative one way and two way video communication methods taking advantage of the network of mobile web cams are described.

Read, U.S. 2004/0066456, discloses a secure image. communications system that includes one or more cameras disposed at a first location, such as a day care center. The system also includes a computer disposed at the first location and connected to the camera or cameras, as the case may be. A server of the system is located at a second location, remote from the first location, but communicatively connected to the computer. The system also includes one or more display devices, which are disparately located remotely from the first location and the second location. Each display device is communicatively connected to the server, for example, via the Internet or other network. The cameras periodically, or virtually continuously, capture images from the first location. The images are saved and manipulated by the computer, for digitization and security. Digital data representative of each image is communicated to the server, via secure channels and schemes. The server enables authorized ones of the display devices to access the digital data, by client-server communications over the Internet or other network between the display device and the server. The display device displays the image rendered from the digital data, in substantially real time.

Coffey et al., U.S. 2004/0123328, discloses a invention that is related to methods and apparatus that conveniently and efficiently provide video surveillance. A mobile surveillance vehicle can be towed to a site by a motor vehicle, such as a car or a truck. The mobile surveillance vehicle includes a video surveillance system, which sends video from the site over the Internet. The video can be provided with wired Internet access or with wireless Internet access. Examples of wireless Internet access include Internet access via. cellular telephony and via satellite. The mobile surveillance vehicle can be self-contained such that no external hookups are used. The video can be provided to a monitoring station, which can communicate with the mobile surveillance vehicle to control video cameras. In one embodiment, video cameras can be mounted to an extendable arm or member, which can extend to provide the video cameras with an elevated perspective.

Kirmuss, U.S. 2003/0081127, discloses a mobile event-recording device that includes distributed elements within, attached to or otherwise mounted to a mobile vehicle, with the principal elements being: a first camera providing a real-time video signal that corresponds to an observed outboard live-motion scene; and a digital video recorder receiving the video signal provided by the camera and recording the video signal in response to a trigger signal (e.g., an activation switch for a light bar or siren, an air bag sensor signal indicating air bag deployment, or depression of an emergency button or a dedicated recording activation switch). The video recorder uses a buffer to receive and store the video signal so as to preserve the video signal during a programmable sliding (or rolling) time interval prior to the triggering event. Thus, in response to provision of the trigger signal, at least a portion of the video signal stored in the buffer is preserved for recording by the video recorder on a hard disk (or other long-term storage medium) and thereafter, the video recorder records directly on the hard disk (or other long-term storage medium).

Gin, U.S. 2003/0093805, discloses an invention that provides a dual camera surveillance and control system. The system comprises a high sensitivity mono camera with enhanced infrared response, an infrared illuminator array for zero ambient light surveillance, and a color camera that does not need to be enhanced in the infra red spectrum. The system also comprises ambient light level sensing, video signal switching technology and power conversion circuitry. The system combines optimized mono imaging under low or no light conditions with optimized color rendered imaging during high ambient light conditions, with both achieving high quality focus. The dual camera nature of the system is transparent to the user due to the integrated automated control of the system, and allows reduced power consumption, making the system suitable for a wireless, remote, self-contained system that draws power from the ambient environment.

Weinstein, U.S. 2003/0163826, discloses a system and method for providing wireless video surveillance of a remote location using microwave transmission of video data using TCP/IP networking protocol. The system comprises a remote unit having one or more analog cameras, a video encoder/decoder linked to a microwave transceiver using Ethernet transceivers connected by a twisted wire pair. The microwave transmission is received by a base unit comprising another microwave transceiver and Ethernet transceiver linked to a computer. The base unit computer is connected to one or more computer networks to enable transmission of the video data to multiple computer terminals on the network.

Kirmuss, U.S. 2003/0081934, discloses systems and techniques for recording video in a mobile environment, in which camera means mounted at a first location in a vehicle generates a video signal based upon an observed scene. Video recording means mounted at a second location in the vehicle inputs and records the video signal on a tangible medium. General-purpose computing means, mounted at a third location in the vehicle and running a general operating system and user-installed application programs, communicates with the video recording means, is loaded with software to provide a user interface to control recording and playback by the video recording means, and includes means for wireless communication with a central base station.

Monroe, U.S. Pat. No. 6,392,692, discloses a wireless security and surveillance system for port, port-to-transport and transport-to-transport communication of data and commands that incorporates a plurality of strategically spaced sensors for monitoring critical conditions, components and critical areas of both the interior and the exterior of the a commercial transport such as an aircraft. The captured data and images are transmitted to a ground based security station for display on a monitor and may be recorded on a “black box” recorder as well as on a ground based recording system. Multiple audio and image signals are multiplexed and sequenced utilizing split screen technology in order to minimize the recording and monitoring hardware required to process the images.

Jones, U.K. 2370902, discloses a vehicle security system that includes a switch D which may be a motion detector responsive to movement o the vehicle's sheets. The switch actuate as processor C including a WAP phone lined to the internet. The processor turns on camera A, B inside the vehicle which record and send images to a central station.

Hendricks et al., U.S. Pat. No. 6,675,386, discloses an invention that relates to a method and apparatus for communicating multiple live video feeds over the internet. Users may be able to view a plurality of remote locations in real time. In another embodiment of the invention, users are able to remotely control a video picture of a distant location. The remote control may be either actual control of a remote video camera or perceived remote control by the manipulation of audiovisual data streams. In one embodiment, text, graphics, and other video information supplement one or more video pictures to provide an educational and entertaining system. In accordance with the present invention, information is accessible to users who are viewing multiple video pictures. The information relates and describes what is being viewed. Users who have different types of equipment, with different data rates, are able to access and use the system of the present invention. In another embodiment, users may interactively communicate with a video lecturer by asking questions and receiving answers. The invention may be connected to, and in communication with, broadcast and/or cable television systems.

Amini et al., U.S. Pat. No. 6,698,021, discloses a system and method for enabling real-time off-site video image storage. An off-site storage site is coupled to camera servers at client sites via a private network. Each camera server is further coupled to one or more surveillance cameras. Video images captured by cameras located at the client sites are forwarded to an off-site server via a camera server. Video images received by the off-site server are produced for live viewing and/or archived in an image database. Users can retrieve live or archived video images through a client workstation that communicates with the off-site server over the internet. Retrieval of video images is based on a web-browser interface. Live viewing of video images is supplemented by real-time camera control functions that alter the pan-tilt-zoom (PTZ) position of the camera producing the live images. Commands for controlling the PTZ camera are encoded by the client workstation and transmitted to the off-site server. The off-site server converts the camera control codes into control strings that are recognizable by the particular camera.

Brown, U.S. Pat. No. 6,709,172, discloses a surveillance system that is provided including a platform having a plurality and variety of cameras or sensors mounted thereto, and a base enclosure adapted to accommodate a power supply, a variety of electronics and other equipment for controlling and providing power to the surveillance equipment. The base is constructed to be tamper resistant and immovable by manual means. A substantially hollow support pole includes a lower portion detachably mounted to the base, and an upper portion mounted to the platform. Wires and cables for connecting the surveillance equipment with the electronics and power supply are run through the support pole. Power to the system may be supplied through existing power sources, for example a 120V power source. A current breaker secured in an environmentally protected housing on the exterior of the surveillance system connected to the power supply and the electronics and surveillance equipment.

Wesselink et al, U.S. Pat. No. 6,709,171 discloses a surveillance system including a platform having a plurality and variety of cameras or sensors mounted thereto, and a base enclosure adapted to accommodate a power supply, a variety of electronics and other equipment for controlling and providing power to the surveillance equipment. The base is constructed to be tamper resistant and immovable by manual means. A substantially hollow support pole includes a lower portion detachably mounted to the base, and an upper portion mounted to the platform. Wires and cables for connecting the surveillance equipment with the electronics and power supply are run through the support pole. Power to the system may be supplied through existing power sources, for example a 120V power source.

Our prior art search with abstracts described above teaches: a portable, wireless monitoring and control, station for use in connection with a multi-media surveillance system having enhanced notification functions; a surveillance system, automobile web cam and communications system incorporating a network of automobile web cams; a dual, camera surveillance and control system; a method and system for remote wireless video surveillance; a temporary surveillance system; a visual imaging network systems and methods including mobile surveillance vehicle mobile digital video recording with pre-event recording; a mobile video recorder control and interference system; an apparatus for video access and control over computer networks, including image correction; a system and method for remote control of surveillance devices; and a temporary surveillance system. Thus, the prior art shows that it is known to provide a surveillance system with plural cameras and tamper resistant elements; wireless surveillance using microwave transmission; systems mounted on mobile vehicles with remote control; separate locations on a vehicle for video viewing, video recording, and digital processing of signals; the use of Internet access; dual camera recording systems using solar energy for remote locating; the use of cellular telephony for transmission of video signals in a surveillance system; self contained systems; multiplexing of signals from several cameras; and sequential camera displays and split screen displays. However, the prior art fails to disclose a single electronic component chassis having integrated there within, a power converter, signal amplifier, computer with cellular modem, and a video capture and record circuit adapted for receiving plural video feeds. The present invention fulfills these needs and provides further related advantages as described in the following summary.

### SUMMARY OF THE INVENTION

The present invention teaches certain benefits in construction and use which give rise to the objectives described below.

In a best mode embodiment of the present invention, a motorized video surveillance apparatus is integrated into a motor vehicle engaging a single equipment chassis and enclosure, interconnected with plural mounted video cameras. The chassis incorporates and integrates a power supply interconnected for operation from the 12 VDC battery source of the motor vehicle, a signal amplifier and transmit-receive output circuit, a digital computer incorporating a cellular modem capable of packet network transmission, and a video capture circuit interconnected with the video cameras for receiving decoding, compressing and recording their video feeds. The video signals are able to be transmitted via the cellular network via the Internet to selected remote locations as well as being stored for later retrieval in the embedded unit. Further, remote viewers are able to select each of the plural video camera feeds.

A primary objective of the present invention is to provide an apparatus and method of use of such apparatus that yields advantages not taught by the prior art by integrating the embedded system into the mobile platform.

Another objective of the invention is to provide live viewing of scenes taken by multiple video cameras from a mobile vehicle while in motion.

A further objective of the invention is to call or activate the video cameras on demand via wireless means.

A still further objective of the invention is to automatically reestablish video feeds after a disturbance.

A yet further objective of the invention is to use GPS signals to identify the location of the mobile vehicle and to communicate such to viewers on demand.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWING

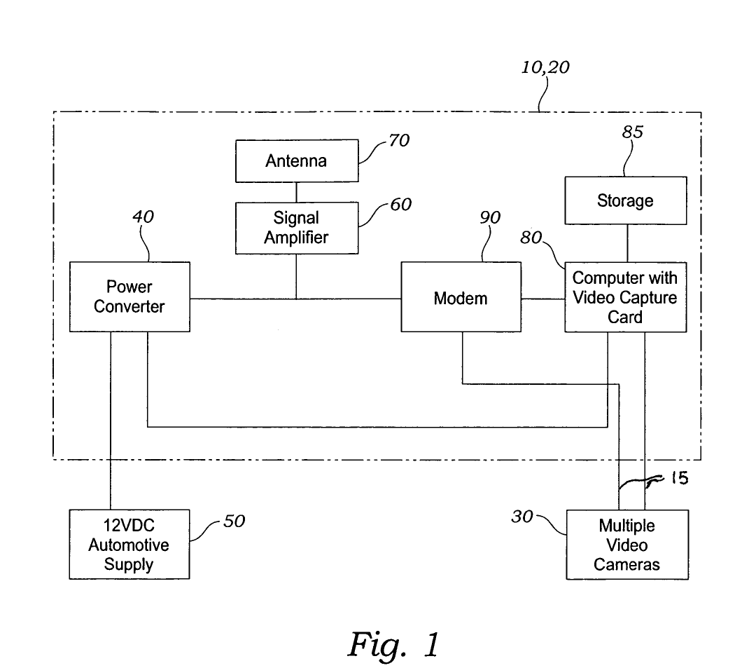

The accompanying block diagram, as FIG. 1, illustrates one embodiment of the present invention. In this drawing it is seen that an integrated chassis encompasses a power converter with cable access for DC battery cable connection, signal amplifier, antenna, an embedded computer circuit with a wireless cellular network adapter, a video capture card or circuit with record capability, a storage device and access for multiple video camera cable feeds.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

In one embodiment of the present invention a self-propelled motorized video surveillance apparatus comprises a motor vehicle, such as van or truck, supporting and engaging a single; equipment chassis mounted circuit 10 mounted within an electrical equipment enclosure 20. The chassis 10 and enclosure 20 is mounted at a location in the vehicle where it can be monitored and operated while the motor vehicle is in motion. Plural video cameras 30 are mounted on the motor vehicle as well, and are interconnected with the circuit 10 by cables 15. The circuit 10 incorporates a power converter 40 powered by a battery source 50, preferably the battery of the vehicle. The circuit 10 further includes, a signal amplifier 60 incorporating a transceiver, and an antenna 70. The circuit 10 further includes a digital computer incorporating a video capture and record circuit 80, a digital storage device 85 such as a hard drive, and a cellular modem 90.

Therefore, through this integrated system video signals are able to be transmitted via the cellular network and the Internet to selected remote viewers of interest, and these viewers are able to remotely select the scenes they wish to view.

Preferably, the digital computer and video capture circuit 80 includes integrated software such that, at will, a remote viewer may select from any one of the camera feeds.

Preferably, the invention further includes a means for accessing and retransmitting GPS data signals and for therefrom determining a current location of the motor vehicle.

Each of the above described circuit elements is well known in the art and the software enablement used by the digital computer is also, one easily applied by one of skill in the art. However, the combination of components and their interconnection scheme is not found in the prior art which is defined in the above background section of this specification.

The enablement described in detail above is considered novel over the prior art of record and is considered critical to the operation of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

Remote aiming of a plurality of video cameras via wireless communication is disclosed by Monroe et al, US 2002/0170064. This references discloses an enhanced, digitized security system providing wireless, portable monitoring and control capability in a system having a plurality of cameras in a network and connected to a suitable hub. The portable module is also in wireless communication with a server. This permits remote installation and aiming of the cameras, remote viewing, remote database access and remote capture of information for transmission to the database server such as images, video, and other security data for archiving and management. This aspect of the present invention operates in essentially the same manner.

The use of Internet pages to display information sent by wireless means from surveillance cameras is taught by Johnson et al, US 2002/0184641 and the present system operates in essentially the same manner.

The method of communicating video images and other surveillance information and signals by cellular telephony and via satellite and with Internet access is disclosed by Coffey et al, US 2004/0123328 and the present system operates in essentially in the same manner. The primary difference is that it is housed in the host vehicle rather than a trailored vehicle and is fully integrated rather than a compilation of sub-systems.

The present information surveillance system is novel with respect to the disclosed references, each alone, or in combination because it is integrated onto a single chassis providing the advantage of the use of a single power supply delivering power voltages and currents as needed by the several circuits shown in FIG. 1, i.e., power amplifier, computer, cellular modem, antenna circuit and video capture circuit. These several circuits are well known and are enabled in this application by incorporation of the several references, but the integration of these circuits into one chassis has not been known. This is because the circuits for low voltage digital computers, for power amplification and transmission of signals and for video feeds are disparate; each requiring quite different signal levels with some signals being analog others digital. The present solution is not novel in its hardware or signal types, but rather in the arrangement and selection of disparate circuits into an integrated unit. Further advantages include compact size, reduction of interconnecting cables and cable and connector types, portability and ease of installation. The present invention is also novel in that it has the ability to be operated while the motor vehicle is in motion.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A mobile video surveillance apparatus consisting of: a self-propelled vehicle engaging a single equipment chassis and enclosure; plural video cameras mounted on the self-propelled vehicle; the equipment chassis incorporating a power converter interconnected for operation from a battery source of the self-propelled vehicle; a computer within the equipment chassis interconnected with a cellular wireless network device, and a video capture circuit; the video capture circuit interconnected with the plural video cameras for receiving and recording video signals therefrom; the chassis further comprising a signal amplifier and transmitter enabled for transmitting the video signals via a cellular telephone network and the Internet to selected remote locations, and whereby remote viewers are enabled for selecting each of the plural video cameras for viewing scenes interior and exterior to the self-propelled vehicle.

2. The apparatus of claim 1 wherein the video capture circuit includes a data processing microcircuit and integrated software.

3. The apparatus of claim 1 further comprising a means for accessing GPS signals and for therefrom determining a current location of the self-propelled vehicle.

4. A mobile video surveillance apparatus consisting of: a self-propelled vehicle engaging a single equipment chassis and enclosure; plural video cameras mounted on the self-propelled vehicle; the equipment chassis incorporating a power converter interconnected for operation from a battery source of the self-propelled vehicle; a computer within the equipment chassis interconnected with a cellular wireless network device, and a video capture circuit including a data processing microcircuit with integrated software; the video capture circuit interconnected with the plural video cameras for receiving and recording video signals therefrom; the chassis further comprising a signal amplifier and transmitter enabled for transmitting the video signals via a cellular telephone network and the Internet to selected remote locations, and whereby remote viewers are enabled for selecting each of the plural video cameras for viewing scenes interior and exterior to the self-propelled vehicle; the apparatus further comprising a means for accessing GPS signals and for therefrom determining a current location of the self-propelled vehicle.

5. The apparatus of claim 4 wherein one of the video cameras is positioned on the self-propelled vehicle for viewing an exterior scene distant from the vehicle.

6. The apparatus of claim 4 wherein one of the video cameras is positioned on the self-propelled vehicle for viewing an exterior scene adjacent the vehicle.

7. The apparatus of claim 4 wherein one of the video cameras is positioned on the self-propelled vehicle for viewing an interior scene within the vehicle.

8. A surveillance apparatus consisting of: a single equipment chassis and enclosure adapted for mounting within a self-propelled vehicle; plural video cameras adapted for mounting on the self-propelled vehicle; the equipment chassis incorporating a power converter interconnected for operation from a battery source of the self-propelled vehicle; a computer within the equipment chassis interconnected with a cellular wireless network device, and a video capture circuit; the video capture circuit interconnected with the plural video cameras for receiving and recording video signals therefrom; the chassis further comprising a signal amplifier and transmitter enabled for transmitting the video signals via a cellular telephone network and the Internet to selected remote locations, and whereby remote viewers are enabled for selecting each of the plural video cameras for viewing scenes interior and exterior to the self-propelled vehicle.
